(19) United States
(12) Patent Application Publication
(10) Pub. No.: US 2023/0255190 A1
(43) Pub. Date: Aug. 17, 2023

(54) A TRAP WITH DETACHABLE LURE OR BAIT CHAMBER

(71) Applicant: CAMRO A/S, Norager (DK)

(72) Inventor: Kurt Sorensen, Norager (DK)

(21) Appl. No.: 18/010,013

(22) PCT Filed: Jun. 10, 2021
(86) PCT No.: PCT/EP2021/065605

§ 371 Date: Dec. 13, 2022

(30) Foreign Application Priority Data
Jun. 15, 2020 (DK) PA 2020 00698

(51) Int. Cl. A01M 23/24

(52) U.S. Cl. CPC A01M 23/245

(57) ABSTRACT

The present invention relates to the use of a detachable lure and/or bait chamber adapted for providing natural illumination in a trap for luring a target species into the kill zone chamber of said trap.

### TECHNICAL FIELD OF THE INVENTION

The present invention relates to the field of traps, especially for rodents.

### BACKGROUND OF THE INVENTION

Rodents, such as rats, inherently fear of being exposed to natural enemies out in the open. Hence, they tend to seek for cover and to move from one cover to the next. Rats are particularly intelligent and inherently sceptical. As they are inherently sceptical about any new objects in their habitat, it takes some time for them to get accustomed to such objects. Thus, when placing a trap, it takes time before the trap is examined and even further time before a rat will enter such a trap. Therefore, a lure or bait is positioned within the trap to overcome the rodent’s scepticism. However, even lure or bait may not be enough for a rat to enter the trap.

### OBJECT OF THE INVENTION

The objective of the present invention is to provide a trap, preferably a rodent trap, that the target animal will feel safer to enter.

### DESCRIPTION OF THE INVENTION

The inventor has found that natural light and fresh air within a trap results in more visits by target animals. It is speculated that this is because fresh air and natural light reminds the rodent that there is a way out of the trap, which is therefore perceived by the rodent to be a good cover. In order to make the rodent as comfortable and safe as possible, the inventor has found that is preferred that the air draft and light comes from the area where the lure or bait is positioned.

A first aspect of the present invention relates to the use of a detachable lure and/or bait chamber adapted for providing natural illumination in a trap, preferably a rodent trap, for luring a target species into the kill zone chamber of said trap.

In one or more embodiments, the lure and/or bait chamber further comprises air ventilation.

In one or more embodiments, the lure and/or bait chamber is further adapted for providing air ventilation into the kill zone chamber of said trap.

A second aspect relates to a trap, preferably a rodent trap, comprising:
a housing with an entrance leading to a kill zone chamber;
a spring driven and/or gas pressure driven killing means adapted for operating within said kill zone chamber;
a trigger mechanism adapted to activate said killing means;
a detachable lure and/or bait chamber directly or indirectly connected to said kill zone chamber, e.g. with a snap lock or the like;
wherein said lure and/or bait chamber is made of a transparent material, thereby allowing for natural illumination of said lure and/or bait chamber.

Mechanical traps are characterised by killing means that strikes the rodent/target animal and almost instantly kills the rodent/target animal. The killing means in mechanical traps are normally spring driven or gas pressure driven and may be recharged by electrical means, springs, or gas pressure driven means. The present invention relates to mechanical traps with a killing means, preferably in the form of a piston or spear. More particularly, the present invention relates to traps with a kill zone and a lure or bait zone positioned in continuation of (e.g. further inside the trap) the kill zone. In this way, the rodent/target animal will have to enter the kill zone to try to reach the lure or bait zone. The spring driven and/or gas pressure driven killing means will operate within the kill zone chamber and is activated when the rodent/target animal activates a trigger mechanism.

The trigger mechanism is preferably positioned either within the kill zone chamber or in an area (trigger zone) positioned between the kill zone chamber and the lure and/or bait chamber. In the latter situation, the lure and/or bait chamber is obviously indirectly coupled to the kill zone chamber via the trigger zone/trigger zone chamber.

For ease of renewing lure or bait within the lure or bait zone, the trap according to the present invention comprises a detachable lure and/or bait chamber connected to said kill zone chamber. To secure natural illumination into said lure and/or bait chamber, it is made of a transparent (optical transparent) material, such as glass or a transparent polymer material, the latter preferably suitable for injection moulding, e.g. PMMA (polymethyl methacrylate); PMMI (polymethylmethacrylimide); Polyester (various homopolyesters, copolyesters and their blends); PC (polycarbonate) and polycarbonate copolymers and their blends; PS (polystyrene) and ABS (acrylonitrile-butadiene-styrene polymers); SAN (styrene-acrylonitrile); ASA (acrylonitrile-styrene) and other styrenic copolymers and their blends; Cellulose esters such as CA, CP and CAB; PI (polyimides) and PEI (polyetherimides), polysulfones and polyethersulfones (PES, PSU, PPSU), polyphenylenes (PPO, PPE), polyacrylates (PAR) and mixtures or blends of these polymers.

The term “transparent” as used herein means that a material transmits some, but preferably most, incident solar light and/or light emitted by the photoluminescent material. More particularly, the term “transparent” means that said material transmits at least 10%, such as at least 20-50%, preferably at least 70%, more preferably at least 90% of said light, measured for light incident perpendicular to the surface of the object that is exposed to said incident light.

In one or more embodiments, the lure and/or bait chamber comprises one or more ventilation channels, preferably 2-20, extending from the outer face to the inner face of said lure and/or bait chamber and in air communication with said entrance via said kill zone chamber. Preferably, the lure and/or bait chamber comprises an opening adapted for receiving a container or insert with lure and/or bait into the lumen of said chamber. Preferably, the container or inert is made from a non-transparent material to protect lure or bait from degrading. The container or inert may be adapted for releasably fastening to the lure and/or bait chamber, but in a way that allows for air passage between the two. Otherwise, the air channels will lose their effect. The opening in the lure and/or bait chamber may be configured as a fastening means adapted for releasably attachment to the kill zone chamber.

The outer face of said lure and/or bait chamber may be shaped to direct wind passing along said outer face into said ventilation channel(s). Alternatively, or in combination, one end (the one facing the outer face) of said ventilation channel is configured as an air guide. Such an air guide may e.g. be a protruding wall or the like, perhaps curved to more easily direct the air flow into the ventilation channel. The individual air guides may be directed in different directions to scavenge air flow from winds coming from varying directions towards the trap.

In one or more embodiments, a wall of said kill zone chamber is configured with a threaded ring-shaped opening, either an internal threading or an external threading; wherein said lure and/or bait chamber is configured with a threaded ring-shaped opening, either an internal threading or an external threading, and wherein said ring-shaped openings are adapted to couple to one another. The threaded ring-shaped opening of the lure and/or bait chamber may be adapted for receiving a container with lure and/or bait into the lumen of said chamber.

In one or more embodiments, a wall of said kill zone chamber is configured with a ring-shaped opening; wherein said lure and/or bait chamber is configured with a ring-shaped opening, and wherein said ring-shaped openings are adapted to couple to one another, e.g. with a snap lock or the like.

As used in the specification and the appended claims, the singular forms “a”, “an”, and “the” include plural referents unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about”, it will be understood that the particular value forms another embodiment.

It should be noted that embodiments and features described in the context of one of the aspects of the present invention also apply to the other aspects of the invention.

### BRIEF DESCRIPTION OF THE FIGURES

FIG. 1 is a cross-sectional view of a trap in accordance with various embodiments of the invention;

FIG. 2 is a perspective view of a lure and/or bait chamber in accordance with various embodiments of the invention;

FIG. 3 shows a lure and/or bait chamber with an insert inside in accordance with various embodiments of the invention; and

FIG. 4 is a perspective of a trap in accordance with various embodiments of the invention.

References

| | |
|---|---|
| 100 | Trap |
| 110 | Entrance |
| 120 | Trigger rod |
| 130 | Gas tank |
| 140 | Lure and/or bait chamber |
| 142 | Ventilation channel |
| 144 | Air guide |
| 146 | Opening |
| 150 | Container/insert |
| 160 | Spring |
| 170 | Kill zone chamber |
| 180 | Piston or spear |
| 190 | Insert |

### DETAILED DESCRIPTION OF THE INVENTION

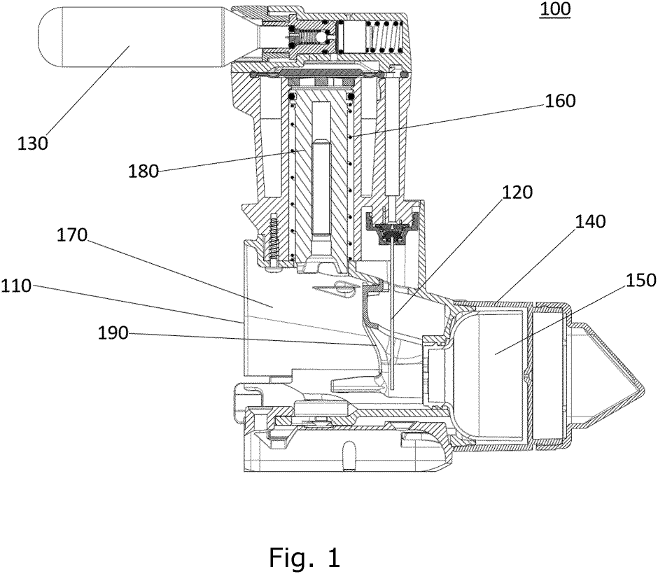

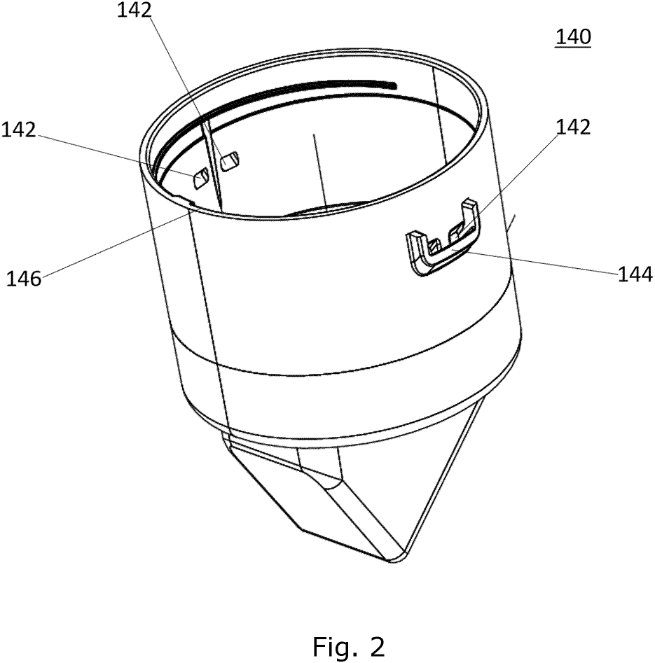

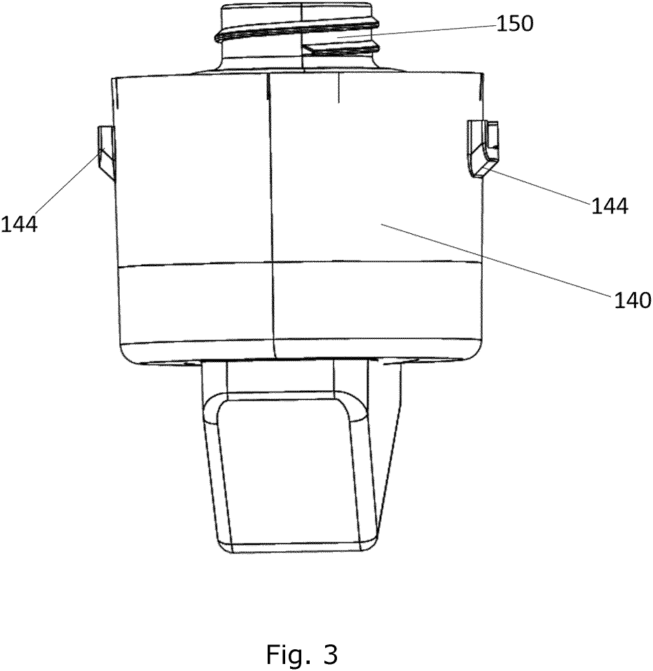

FIG. 1 is a cross-sectional view of a trap in accordance with various embodiments of the invention. The trap 100 is here shown with a killing means in the form of a piston or spear 180. The piston or spear 180 is both gas driven, and spring driven. The gas tank 130 and the spring 160 are shown. The piston or spear 180 is shown in a retracted position and is activated by the trigger rod 120 (trigger mechanism). The piston or spear 180 is preferably made from a polymeric material that is preferably injection mouldable, such as plastic, e.g. polyethylene, polyoxymethylene, or polyethylene. The piston or spear 180 could though be made of metal, such as steel or the like. The trap 100 also comprises a housing with an entrance 110 leading to a kill zone chamber 170, wherein, in this embodiment, the trigger rod 120 is positioned. The kill zone chamber 170 is where the target animal is killed. A detachable lure and/or bait chamber 140 is directly connected to the kill zone chamber 170, and is made of a transparent material, thereby allowing for natural illumination of said lure and/or bait chamber 140. If the trap is positioned within a trap casing, this casing should be configured with holes, slots, windows, or channels adapted for admitting sunlight to enter the lumen. Otherwise, the effect of a transparent lure and/or bait chamber is obviously hindered. The lure and/or bait chamber 140 comprises an opening 146 (FIG. 2) adapted for receiving a container or insert 150 with lure and/or bait into the lumen of said chamber 140. In FIGS. 1 and 3, the container or insert 150 may be seen positioned within the lumen of the lure and/or bait chamber 140. The container or insert 150 may be made from a non-transparent material to protect the lure or bait from degrading. The lure and/or bait chamber 140 comprises four ventilation channels 142 extending from the outer face to the inner face of said lure and/or bait chamber 140 and in air communication with said entrance 110 via said kill zone chamber 170.

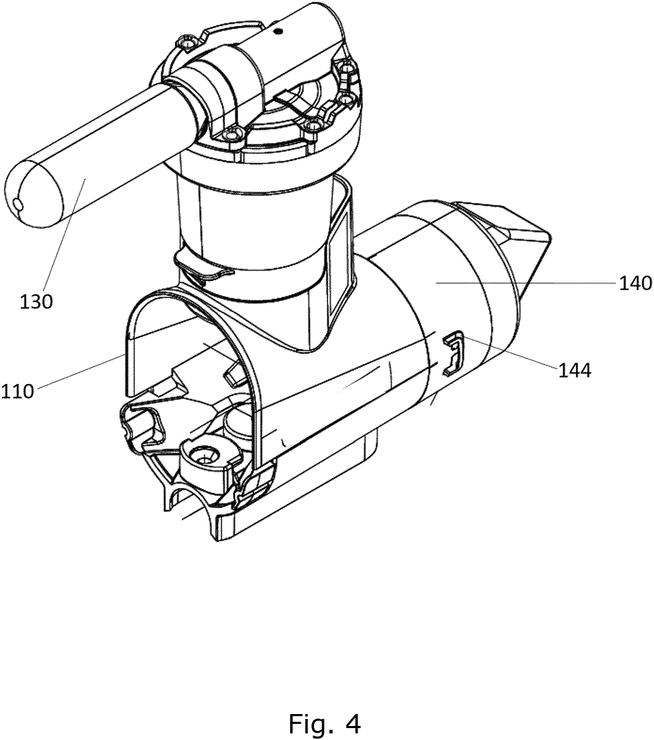

FIG. 4 is a perspective of a trap in accordance with various embodiments of the invention. As can be seen in FIGS. 2-4, one end of the ventilation channels 142 is configured as an air guide 144.

In FIG. 1, an insert 190 is positioned (releasably fastened) within the kill zone chamber 170 and in front of the trigger rod 120. The intention is that only targeted animals can reach the trigger rod 120. Hence, the insert 190 is adapted for restricting the height and width of the part of the kill zone chamber 170, where the trigger rod 120 is positioned. The insert may be selected from a kit of inserts, each adapted for targeting a specific animal/specie.

1. A method comprising using a detachable lure and/or bait chamber (140) adapted for providing natural illumination in a trap (100) for luring a target species into the kill zone chamber (170) of said trap (100).

2. The method according to claim 1, wherein said lure and/or bait chamber (140) further comprises air ventilation.

3. A trap (100) comprising:
a housing with an entrance (110) leading to a kill zone chamber (170);
a spring driven and/or gas pressure driven killing means (180) adapted for operating within said kill zone chamber (170);
a trigger mechanism (120) adapted to activate said killing means (180);
a detachable lure and/or bait chamber (140) directly or indirectly connected to said kill zone chamber (170);
wherein said lure and/or bait chamber (140) is made of a transparent material, thereby allowing for natural illumination of said lure and/or bait chamber (140).

4. The trap (100) according to claim 3, wherein said lure and/or bait chamber (140) comprises one or more ventilation channels (142) extending from the outer face to the inner face of said lure and/or bait chamber (140) and in air communication with said entrance (110) via said kill zone chamber (170).

5. The trap (100) according to claim 4, wherein the outer face of said lure and/or bait chamber (140) is shaped to direct wind passing along said outer face into said ventilation channel(s) (142).

6. The trap (100) according to claim 4, wherein one end of said ventilation channel (142) is configured as an air guide (144).

7. The trap (100) according to claim 3, wherein a wall of said kill zone chamber (170) is configured with a ring-shaped opening (172); wherein said lure and/or bait chamber (140) is configured with a ring-shaped opening (146), and wherein said ring-shaped openings (172, 146) are adapted to couple to one another.

8. The trap (100) according to claim 3, wherein the lure and/or bait chamber (140) comprises an opening (146) adapted for receiving a container or insert (150) with lure and/or bait into the lumen of said chamber (140).

9. The trap (100) according to claim 8, wherein the container or inert (150) is made from a non-transparent material to protect the lure or bait from degrading.

10. The trap (100) according to claim 8, wherein said opening (146) in the lure and/or bait chamber (140) is configured as a fastening means, e.g. threaded, adapted for releasably attachment to said kill zone chamber (170).
